(19) United States
(12) Patent Application Publication
(10) Pub. No.: US 2025/0337440 A1
(43) Pub. Date: Oct. 30, 2025

(54) METHOD FOR CREATING HIGH POWER, MULTI-BAND, ELECTRONICALLY STEERABLE RADIO FREQUENCY ARRAYS USING SPATIALLY OVERSAMPLED ANTENNA ARRAYS WITH COMMODITY ELECTRONICS

(71) Applicant: Battelle Memorial Institute, Columbus, OH (US)

(72) Inventor: Douglas A. Thornton, Columbus, OH (US)

(21) Appl. No.: 19/187,150

(22) Filed: Apr. 23, 2025

Related U.S. Application Data
(60) Provisional application No. 63/638,480, filed on Apr. 25, 2024.

(51) Int. Cl. H04B 1/00; H01Q 5/20; H04B 7/0413

(52) U.S. Cl. CPC H04B 1/0057; H01Q 5/20; H04B 7/0413

(57) ABSTRACT

In an approach to telecommunications, a system includes a spatially oversampled array comprising a plurality of antenna elements, the spatially oversampled array configured to space the plurality of antenna elements closer than one half of a wavelength of a predetermined bandwidth; and a plurality of element analog front ends (eAFEs), where each of the plurality of eAFEs is disposed on and communicatively coupled to one of the plurality of antenna elements.

### CROSS-REFERENCE TO RELATED APPLICATIONS

The present application claims the benefit of the filing date of U.S. Provisional Application Ser. No. 63/638,480, filed Apr. 25, 2024, the entire teachings of which application is hereby incorporated herein by reference.

### TECHNICAL FIELD

The present disclosure generally relates to telecommunication, and specifically to systems of high power, multi-band, electronically steerable radio frequency arrays and methods for creating such systems using spatially oversampled antenna arrays with commodity electronics.

### BACKGROUND

Conventional radio design of fixed infrastructure makes design assumptions that minimize the number of antenna elements for a specific size and gain, placing stringent requirements on amplifiers and filters to operate in high powers. The result is an intuitively cost and complexity optimized radio. However, when one considers the optimizations in size, power, and performance of consumer devices such as cellular phones, one can quickly see that there being 1,000 cell phones per tower, provides a cost scaling and therefore investment scaling.

This disclosure utilizes the 1000x scaling to obtain performance and price benefits over existing conventional approaches. While using 1024 analog front ends (e.g., front end components) instead of the 64 analog front ends typical in current radio design, the system and/or method of this disclosure leverages an economy of scale. Keeping each of the analog front ends low power, cooling becomes easier, because the head load is dispersed between a greater number of lower power heat sources. The radio frequency (RF) performance improves because the non-linearities of the amplifiers and filters are often stochastic, and therefore partially cancel among the elements, which improves noise figure and error vector magnitude, all increasing throughput for the same channel state. Moreover, since each element is lower power and inherently multi-band, the system can achieve optimal filtering, intermodulation distortion, and power efficiency. Lower power signals are capable of using surface acoustic wave (SAW) and bulk acoustic wave (BAW) type filters, which can be small and integrated into integrated circuits (ICs), versus the large discrete filters required by high power devices. The system can achieve these benefits utilizing a spatially oversampling array.

### BRIEF DESCRIPTION OF THE DRAWINGS

Reference should be made to the following detailed description which should be read in conjunction with the following figures, wherein like numerals represent like parts.

FIG. 1 illustrates a system to a telecommunications system utilizing a spatially oversampled array consistent with the present disclosure.

FIG. 2 illustrates an element analog front end (eAFE) of the system consistent with the present disclosure.

FIG. 3 illustrates a flowchart for an example method for building a telecommunications system utilizing a spatially oversampled array consistent with the present disclosure.

FIG. 4 illustrates an existing, conventional telecommunications system consistent with the present disclosure.

### DETAILED DESCRIPTION

As used in this disclosure, an “element” means a singularly polarized radiating antenna that is grouped in an array. A “channel” refers to a signal transition point between the digital domain and the analog domain. A “stream” may represent an independent frequency and spatial radio frequency (RF) data combination; often considered spatial streams or layers. Additionally, “beamforming” may refer to a technique by which an array of antennas can be steered to transmit or receive radio signals in a specific direction to improve the signal-to-noise ratio of receive (RX) signals by eliminating undesired interference sources and transmitting the signals to specific locations.

An antenna array system is a new technology that transforms an antenna design, so the system is no longer bound by physical limitations of existing antenna hardware. The resulting system has a size that is application dependent and may replace multiple antennas that only support a single frequency. Instead, the array system contains a group of antennas, called an array, configured to support a wide range of frequencies. This array system is four times more efficient at using radio spectrum than existing antenna applications. Thus, the array system enables a sleek and cost-efficient solution for ultra-wide bandwidth. For example, the RavenStar antenna system, an ultra-wide bandwidth steerable radio unit with an integrated antenna, is such an array system. The RavenStar antenna system can simultaneously support the entire Frequency Range 1 band (400 MHz to 7.125 GHz), including 4G and 5G, from a single array.

The RavenStar antenna system scales down the number of devices needed to provide always on, high bandwidth delivery while minimizing the footprint on a tower. Additionally, the RavenStar antenna system can operate on frequencies for Wi-Fi routers, the low cell phone frequencies that work well in a basement, the high frequencies that let consumers stream videos in a crowd, and more—with an array that does not interrupt signals, even when placed close together.

To use an analogy, most antennas are like flashlights: while rapidly moving a bright beam, the antenna can do only a single frequency, or color. The RavenStar antenna system, however, operates like having many different colored flashlights all rapidly moving over the area, lighting it all up at once.

Generally, an antenna array system, such as the RavenStar antenna system, may be deployed in three approaches, maximum flexibility, minimum size, weight, and power, and active cancellation.

The maximum flexibility is appropriate for neutral hosts or operators who need to dynamically change bands and support a significant number of bands (e.g., more than five bands). The minimum size, weight and power approach is best for deployments on fixed frequencies that need to consolidate space and install efforts. The active cancellation approach provides the highest flexibility and performance but may not be cost and space effective for commercial cellular applications.

In beamforming systems, the number of channels may define the fidelity in which spatial beam patterns can be manufactured. The number of streams is decoupled from the number of channels and is largely based upon the processing power and fronthaul requirements, combined with the reduced likelihood of independence of the streams as the number is increased.

Accordingly, the system and/or method of this disclosure utilize a spatially oversampled array to take advantage of the minimum size, weight, and power approach to achieve optimized performance, flexibility, and overall cost. As used herein, a spatially oversampled array is defined as an array comprising a plurality of antenna elements configured to space the plurality of antenna elements closer than one half of a wavelength of a predetermined bandwidth to increase the total number of analog front ends required therein.

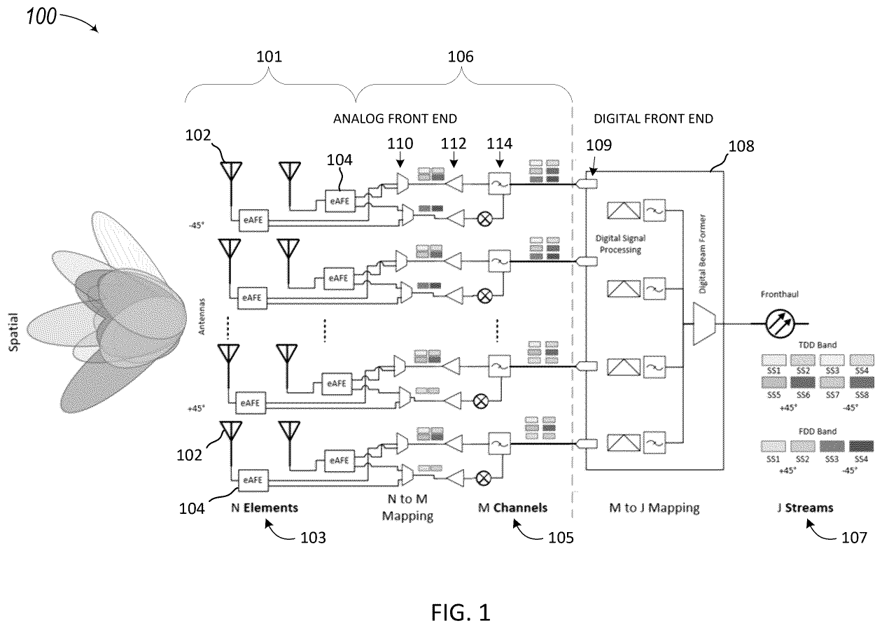

FIG. 1 is an illustrative example embodiment of a telecommunications system 100 configured to achieve minimum size, weight, and power requirements for communication applications for a predetermined number of fixed bandwidths. Specifically, the predetermined number of fixed bandwidths (or bands) may include, but is not limited to, a number in 1-3, 10-20, or any number in the range of 1-30.

More specifically, the system 100 comprises a spatially oversampled array 101, as shown in FIG. 1. In some embodiments, the spatially oversampled array 101 may include a plurality of antenna elements 102, and the spatially oversampled array 101 is configured to space the plurality of antenna elements 102 closer than one half of a wavelength of a predetermined bandwidth to increase the total number of analog front ends required therein.

For example, the predetermined bandwidth may include a first bandwidth from a plurality of bandwidths; and the first bandwidth, among those of the plurality of bandwidths, may have the highest frequency.

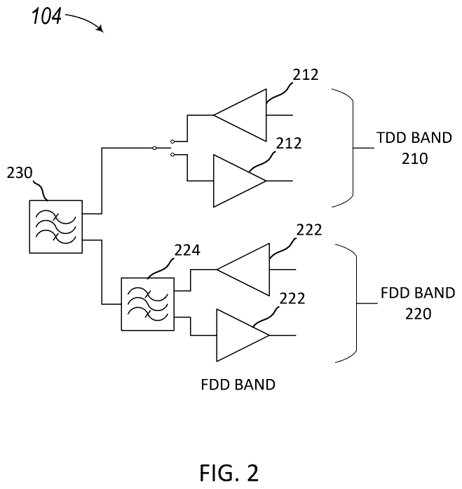

As shown in FIG. 1 and FIG. 2, in some embodiments, each of the plurality of antenna elements 102 may be an antenna aperture and may include an element analog front end (eAFE) 104. The eAFE 104 is disposed on and coupled to the antenna element 102. In some embodiments, the eAFE 104 is selected and optimized to reduce size, weight, and power of the system 100 based on a power requirement of the first bandwidth. For example, the eAFE 104 may be selected from existing off-shelf electronic components (e.g., suitable commodity electronic parts) and/or manufactured at low costs with available off-shelf parts. Specifically, each eAFE 104 may include, but is not limited to, a chip, an IC, a circuitry, a microprocessor, or any suitable components, to ensure multi-band operation, including, e.g., diplexing/triplexing, filtering such as frequency division duplex (FDD) bandpass filter 224 and time division duplex (TDD) bandpass filter 230, and amplification of TDD and/or FDD bands from an antenna aperture, such as TDD band amplifiers 212 and FDD band amplifiers 222, as shown in FIG. 2. In some embodiments, the eAFE 104 may also include one or more low-power monolithic microwave integrated circuit (MMIC) scale device, e.g., MMIC scale devices having an average power of approximately 23-30 dBm. Moreover, each eAFE 104 may be a part of an integrated circuit, system on chip, or standalone unit. Furthermore, the eAFE 104 may be configured to provide mixing of an occupied bandwidth of lower order multiple-input/multiple-output (MIMO) signals into the instantaneous band supporting higher order MIMO signals.

By setting the power output of each eAFE 104 to be the same power limits imposed upon consumer devices (e.g., mobile phones), the number of eAFEs 104 can be determined to achieve that power and define the size of each eAFE 104. These analog front end devices (i.e., front ends), e.g., eAFEs 104, are highly integrated and multi-band. By utilizing these front ends, a very high density of signal chains and thus antenna elements, e.g., eAFEs 104, can be achieved.

Therefore, in an embodiment, the power for each eAFE 10 may be low enabling the use of approximately 23-30 dBm MMIC scale devices. Additionally, the eAFE 104 allows filtering that enables operating amplifiers in higher efficiency modes. The separation of bands enables mixing the occupied bandwidth of the lower order MIMO signals into the instantaneous band supporting the higher order MIMO signal. When the total signal occupied bandwidth is less than a processor's capability (for example, a typical system with a 200 MHz occupied bandwidth supports the combination of a 100 MHz TDD signal with a 40 MHz FDD signal, and 20 MHz FDD signal), and thus, mapping the signals together reduces cost and power by fully utilizing the capabilities of the processor. Further, the system 100 provides massive MIMO functions for the lower bands, improving signal dynamic range, noise figure, and the ability to digitally create beams and nulls.

In some embodiments, the system 100 may comprise a plurality of element-to-channel converters 106 and a digital beamformer 108, as shown in FIG. 1. The plurality of element-to-channel converters 106 is configured to convert between a plurality of analog antenna signal elements 103 and a plurality of analog signal channels 105. Specifically, each of the plurality of element-to-channel converters 106 is configured to map the plurality of antenna signal elements 103, e.g., the plurality of eAFEs 104 (i.e., NeAFEs 104 in the example of FIG. 1), into the plurality of analog signal channels 105 (i.e., M analog signal channels 105 in the example of FIG. 1). Moreover, each of the plurality of element-to-channel converters 106 may include, but is not limited to, a splitters/combiners 110, pre-amplifiers 112 such as power amplifiers and/or low noise amplifiers, filters 114, transmit/receive switches, etc., for operation of a specific band. Thus, via the plurality of element-to-channel converters 106, the system 100 is configured to ensure a frequency division duplexing signal can operate simultaneously with a time division duplexing signal in another band, and the power efficiency of utilizing a transmit receive switch is maintained.

As illustrated in FIG. 1, in some embodiments, the digital beamformer 108 converts between the plurality of analog signal channels 105 into a plurality of data streams 107 (i.e., J data streams 107 in the example of FIG. 1). Moreover, the digital beamformer 108 may include a plurality of analog-to-digital converters and digital-to-analog converters (ADCs/DACs) 109. It should be noted that each of the plurality of (ADCs/DACs) 109 may comprise one or more ADCs, one or more DACs, or any combination of both ADCs and DACs. Each of the plurality of ADCs/DACs 109 is coupled with the plurality of element-to-channel converters 106. Specifically, individual ADCs/DACs 109 convert between the plurality of analog signal channels 105 and the plurality of data streams 107. In some embodiments, the digital beamformer 108 may be configured to upconvert/downconvert two or more frequency bands so that an occupied bandwidth of an eAFE 104 is within the instantaneous bandwidth of the individual ADCs/DACs 109.

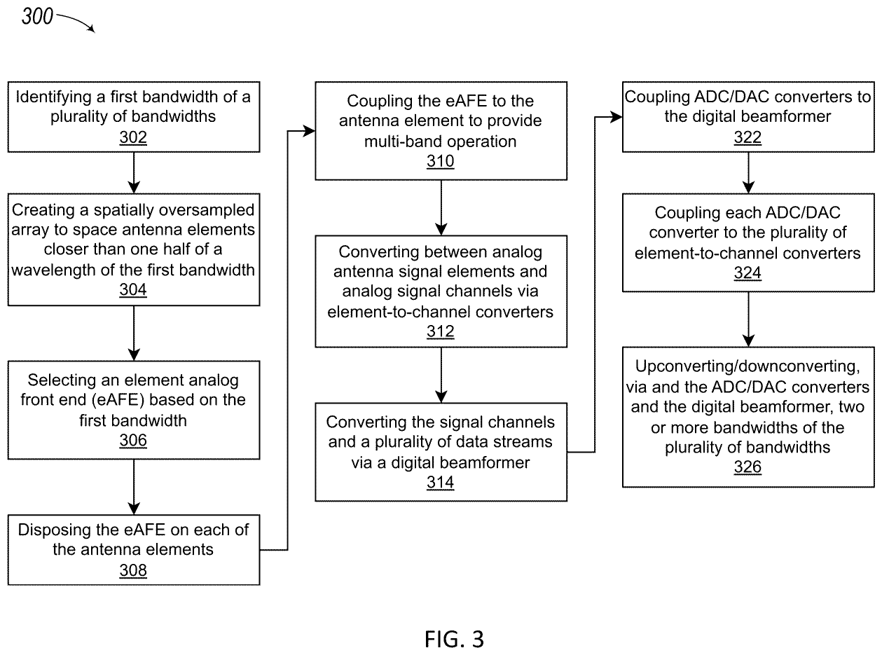

FIG. 3 illustrates a method 300 for building a telecommunication system. In some embodiments, the method 300 may comprise identifying a first bandwidth of a plurality of bandwidths, the first bandwidth comprising a highest frequency among all frequencies of the plurality of bandwidths 302. The first bandwidth may be used to design an optimized telecommunication system, especially an analog and digital front end to reduce size, weight, and power. The method 300 then creates a spatially oversampled array to space a plurality of antenna elements, such as antenna elements 102 from FIG. 1, closer than one half of a wavelength of the first bandwidth 304; and selects an element analog front end, such as eAFE 104 from FIG. 1, based on a power requirement of the first bandwidth 306. In some embodiments, the method 300 may include selecting eAFEs from existing off-shelf electronic components and/or manufacturing eAFEs at low costs with available off-shelf parts. Subsequently, the method 300 disposes the eAFE on each of the plurality of antenna elements 308; and couples the eAFE to each of the plurality of antenna elements to provide multi-band operation thereof 310.

In some embodiments, the eAFE of the method 300 may be configured to provide a multi-band operation including diplexing/triplexing, filtering, and/or amplification. Moreover, the eAFE may be configured to provide mixing of an occupied bandwidth of lower order MIMO signals into the instantaneous band supporting higher order MIMO signals.

The method 300, as shown in FIG. 3, may further comprise converting between a plurality of analog antenna signal elements of the plurality of antenna elements and a plurality of analog signal channels via a plurality of element-to-channel converters 312; and converting the plurality of analog signal channels and a plurality of data streams via a digital beamformer 314.

In some embodiments, as illustrated in FIG. 3, the step 314 of the method 300 may include coupling a plurality of ADCs/DACs to the digital beamformer 322, such as the digital beamformer 108 from FIG. 1; and coupling each of the plurality of ADCs/DACs with the plurality of element-to-channel converters 324. Furthermore, the method 300 includes upconverting/downconverting, via the plurality of ADCs/DACs, such as the ADCs/DACs 109 from FIG. 1, and the digital beamformer, two or more bandwidths of the plurality of bandwidths so that an occupied bandwidth of an eAFE is within the instantaneous bandwidth of the individual ADCs/DACs of the plurality of ADCs/DACs.

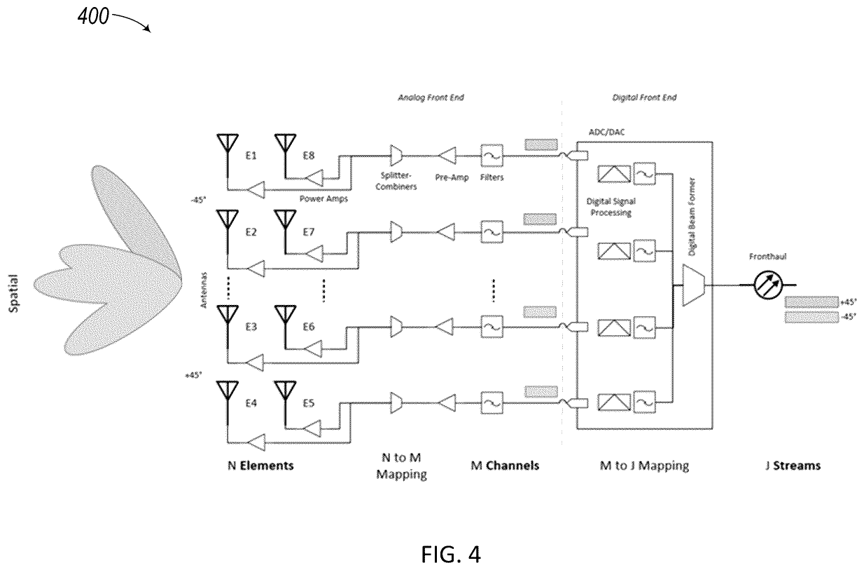

FIG. 4 illustrates an example of an existing antenna system, e.g., the RavenStar antenna system, which differs from the system 100 and method 300. The existing antenna system utilizes the frequency flexible approach that to attempt to provide maximum system flexibility. Specifically, the system comprises antenna elements that are mapped to a lesser number of channels. These channels are then digitally beamformed to create multiple streams. For a multi-band system, the mapping of elements to channels can be different per band. Polarization diversity is always used requiring a minimum channel count of 2. In FIG. 4, only transmit (TX) mode is shown for simplicity.

The example antenna system shown in FIG. 4 utilizes a frequency flexible approach, as described above. This system enables a user to dynamically and digitally assign the amount of aperture resources to dedicate to a particular signal. For example, the full aperture of an antenna can be used in massive MIMO mode, or the aperture can be sub-divided into multiple 4T4R (4 Transmit 4 Receive) or 2T2R (2 Transmit 2 Receive) solutions, and that assignment can change based upon time of day, user demands, price of power, etc., to obtain optimal revenue per site.

In this example antenna system, all signal chains are wideband and operated in linear mode, with band filtering at the channel level. This approach can provide tens of dynamically selectable bands with SAW and BAW filters or provide digital filtering with less roll off. Each element is only used for one band at a time. Multi-band operation is achieved by assigning portions of the array to different bands. FDD and unsynchronized TDD signals are handled by splitting the aperture and providing passive isolation between TX and RX. The one signal per element and split aperture approach makes the size of the solution greater than fixed frequency units, and the use of linear power amplifiers results in lower efficiency than fixed frequency units.

Notably, existing systems such as the one illustrated in FIG. 4 are distinguishable from the system and/or method of this disclosure, which takes advantage of the minimum size, weight, and power approach to achieve optimized performance, flexibility, and overall cost.

According to one aspect of the disclosure there is thus provided a system for telecommunications, the system including: a spatially oversampled array comprising a plurality of antenna elements, the spatially oversampled array configured to space the plurality of antenna elements closer than one half of a wavelength of a predetermined bandwidth; and a plurality of element analog front ends (eAFEs), where each of the plurality of eAFEs is disposed on and communicatively coupled to one of the plurality of antenna elements.

According to another aspect of the disclosure, there is provided a method of building a telecommunication system, the method including: identifying a first bandwidth of a plurality of bandwidths, the first bandwidth comprising a highest frequency among all frequencies of the plurality of bandwidths; creating a spatially oversampled array to space a plurality of antenna elements closer than one half of a wavelength of the first bandwidth; selecting an element analog front end (eAFE) based on a power requirement of the first bandwidth; disposing the eAFE on each of the plurality of antenna elements; and coupling the eAFE to each of the plurality of antenna elements to provide multi-band operation.

According to yet another aspect of the disclosure, there is thus provided a system for electronically steerable radio frequency arrays, the system including: a spatially oversampled array; a plurality of antenna elements, the plurality of antenna elements each including an element analog front end (eAFE); a plurality of element-to-channel converters; and a digital beamformer, where the spatially oversampled array comprising the plurality of antenna elements and configured to space the plurality of antenna elements closer than one half of a wavelength of a predetermined bandwidth.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art. Also, it may be appreciated that the phraseology and terminology used herein is for the purpose of description and should not be regarded as limiting as such may be understood by one of skill in the art. Throughout the present disclosure, like reference characters may indicate like structure throughout the several views, and such structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable, and not exclusive.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

What is claimed is:

1. A system for telecommunications, the system comprising:
a spatially oversampled array comprising a plurality of antenna elements, the spatially oversampled array configured to space the plurality of antenna elements closer than one half of a wavelength of a predetermined bandwidth; and
a plurality of element analog front ends (eAFEs), wherein:
each of the plurality of eAFEs is disposed on and communicatively coupled to one of the plurality of antenna elements.

2. The system of claim 1, wherein each of the plurality of eAFEs is configured to provide a multi-band operation.

3. The system of claim 2, wherein each of the plurality of eAFEs further comprises:
at least one of diplexing/triplexing, filtering, and amplification.

4. The system of claim 1, wherein each of the plurality of eAFEs comprises at least one of an integrated circuit, a system on chip, or a standalone unit.

5. The system of claim 1, wherein:
the predetermined bandwidth comprises a first bandwidth from a plurality of bandwidths; and
the first bandwidth has a highest frequency among all frequencies of the plurality of bandwidths.

6. The system of claim 5, wherein each of the plurality of eAFEs is selected based on a power requirement of the first bandwidth.

7. The system of claim 5, wherein a total number of bandwidths of the plurality of bandwidths is in a range of 1-30.

8. The system of claim 7, wherein each of the plurality of eAFEs comprises one or more monolithic microwave integrated circuit (MMIC) devices.

9. The system of claim 8, wherein the one or more MMIC scale devices having an average power in the range of 23-30 dBm.

10. The system of claim 7, wherein each of the plurality of eAFEs is configured to provide mixing of an occupied bandwidth of lower order multiple-input/multiple-output (MIMO) signals into an instantaneous band supporting higher order MIMO signals.

11. The system of claim 5, further comprising:
a plurality of element-to-channel converters configured to convert between a plurality of analog antenna signal elements and a plurality of analog signal channels; and
a digital beamformer configured to convert between a plurality of analog signal channels and a plurality of data streams.

12. The system of claim 11, wherein:
the digital beamformer further comprises a plurality of analog-to-digital converters and digital-to-analog converters (ADCs/DACs);
each of the plurality of ADCs/DACs is coupled with one of the plurality of element-to-channel converter;
the plurality of ADCs/DACs is configured to convert between the plurality of analog signal channels and the plurality of data streams; and
the digital beamformer is configured to upconvert/downconvert two or more bandwidths of the plurality of bandwidths so that an occupied bandwidth of the plurality of eAFEs is within an instantaneous bandwidth of each of the plurality of ADCs/DACs.

13. A method for building a telecommunication system, the method comprising:
identifying a first bandwidth of a plurality of bandwidths, the first bandwidth comprising a highest frequency among all frequencies of the plurality of bandwidths;
creating a spatially oversampled array to space a plurality of antenna elements closer than one half of a wavelength of the first bandwidth;
selecting an element analog front end (eAFE) based on a power requirement of the first bandwidth;
disposing the eAFE on each of the plurality of antenna elements; and
coupling the eAFE to each of the plurality of antenna elements to provide multi-band operation.

14. The method of claim 13, wherein the eAFE is configured to provide a multi-band operation including diplexing/triplexing, filtering, and/or amplification.

15. The method of claim 13, wherein the eAFE is configured to provide mixing of an occupied bandwidth of lower order multiple-input/multiple-output (MIMO) signals into an instantaneous band supporting higher order MIMO signals.

16. The method of claim 13, further comprising:
converting between a plurality of analog antenna signal elements of the plurality of antenna elements and a plurality of analog signal channels via a plurality of element-to-channel converters; and
converting the plurality of analog signal channels and a plurality of data streams via a digital beamformer.

17. The method of claim 16, further comprising:
coupling a plurality of analog-to-digital converters and digital-to-analog converters (ADCs/DACs) to the digital beamformer;
coupling each of the plurality of ADCs/DACs with the plurality of element-to-channel converters; and
upconverting/downconverting, via the plurality of ADCs/DACs and the digital beamformer, two or more bandwidths of the plurality of bandwidths so that an occupied bandwidth of an eAFE is within an instantaneous bandwidth of each of the plurality of ADCs/DACs.

18. A system for electronically steerable radio frequency arrays, the system comprising:
a spatially oversampled array;
a plurality of antenna elements, the plurality of antenna elements each including an element analog front end (eAFE);
a plurality of element-to-channel converters; and
a digital beamformer, wherein:
the spatially oversampled array comprising the plurality of antenna elements and configured to space the plurality of antenna elements closer than one half of a wavelength of a predetermined bandwidth.

19. The system of claim 18, wherein each of the plurality of element-to-channel converters is configured to convert between a plurality of analog antenna signal elements and a plurality of analog signal channels.

20. The system of claim 18, further comprising:
a first bandwidth of a plurality of bandwidths; and
the first bandwidth has a highest frequency among all frequencies of the plurality of bandwidths.
